(19) United States
(12) Patent Application Publication
(10) Pub. No.: US 2010/0020783 A1
(43) Pub. Date: Jan. 28, 2010

(54) PROCESSES INVOLVING NON-COHERENT INTEGRATION IN A RECEIVER

(76) Inventors: Harri Valio, Kammenniemi (FI); Samuli Pietila, Tampere (FI)

Correspondence Address: HARRINGTON & SMITH, PC, 4 RESEARCH DRIVE, Suite 202, SHELTON, CT, 06484-6212, US

(21) Appl. No.: 12/310,462

(22) PCT Filed: Sep. 8, 2006
(86) PCT No.: PCT/IB2006/003862

§ 371 Date: Oct. 1, 2009

(51) Int. Cl. H04B 7/208

(52) U.S. Cl. 370/344

(57) ABSTRACT

A non-coherent integration period is divided into a plurality of epochs and a frequency space is divided into a plurality of sub-spaces. A result of a first non-coherent integration in a first frequency sub-space over a first epoch is combined with a result of a second non-coherent integration in a second frequency sub-space over a second epoch. A method of non-coherent integration in an environment subject to drift of a time reference, the method including: creating a first putative non-coherent integration value by assuming no-drift of the time reference; creating a second putative non-coherent integration value by assuming drift of a first rate of the time reference; and determining a non-coherent integration value using the first putative non-coherent integration value and the second putative non-coherent integration value. A method including: storing first data associated with non-coherent integration, over only a first epoch, of a signal occupying only a first frequency space; and storing second data associated with non-coherent integration, over only a second epoch, of a signal occupying only a second frequency space, wherein the first epoch precedes the second epoch and the first frequency space is smaller than the second frequency space.

### FIELD OF THE INVENTION

Embodiments of the present invention relate to improved processes using non-coherent integration. In particular, some embodiments relate to improved processes using non-coherent integration in Global Navigation Satellite System (GNSS) receiver circuitry.

### BACKGROUND TO THE INVENTION

Some Global Navigation Satellite (GNSS) Systems such as Global Positioning Systems (GPS) and the proposed European system Galileo use Code Division Multiple Access (CDMA). This access scheme enables multiple communication channels to share a single frequency band by using orthogonal chipping codes to spread the data across the full frequency band. The chipping codes are also called pseudo random noise codes. A different chipping code is assigned to each satellite communication channel but all the satellite communication channels share the same frequency band.

Another Global Navigation Satellite System, GLONASS, uses frequency division multiple access. A different frequency band is assigned to each satellite communication channel but all the satellite communication channels share the same chipping code.

For the sake of simplicity, reference will now be made to a GNSS receiver, however, it should be appreciated that embodiments of the invention find application in other types of radio receivers.

A GNSS receiver is a complex system. It typically comprises an RF engine for demodulating RF signals, a measurement engine for acquiring the satellite communication channels, for tracking the satellite communication channels and for recovering transmitted data from each of the satellite communication channels and a position engine for solving time and geometric unknowns using the recovered data.

Acquisition is a complex process. The communication channel parameters are unknown and therefore “processing” is required to find those parameters. For a GPS system, which uses CDMA, the unknown parameters of the communication channel are the chipping code, the phase of the chipping code and the exact carrier frequency as modified by, for example, Doppler shifting.

The modified carrier frequency is typically found by performing frequency analysis and signal detection on the received signal.

The frequency analysis typically involves converting the signal from the time domain to the frequency domain using a fast Fourier transform (FFT). Identifying the frequency bin at which the strongest signal is detected identifies the modified carrier frequency.

As the signal strength is low, its strength and signal to noise ration may be improved by performing coherent integration, converting the integrated signal to a scalar value and then non-coherently integrating the scalar value.

There are a number of problems associated with this approach.

As the length of coherent integration increases, the number of the frequency bins required increases and more memory storage capacity is required.

As the length of non-coherent integration increases, the effect of clock drift in the receiver may spread the signal over multiple frequency bins.

### BRIEF DESCRIPTION OF THE INVENTION

According to one embodiment of the invention there is provided a method in which a non-coherent integration period is divided into a plurality of epochs and a frequency space is divided into a plurality of sub-spaces, the method comprising: combining a result of a first non-coherent integration in a first frequency sub-space over a first epoch with a result of a second non-coherent integration in a second frequency sub-space over a second epoch.

According to another embodiment of the invention there is provided circuitry comprising: first circuitry arranged to perform a first non-coherent integration in a first frequency sub-space over a first epoch and a second non-coherent integration in a second frequency sub-space over a second epoch, and second circuitry arranged to combine a result of the first non-coherent integration with a result of the second non-coherent integration.

According to another embodiment of the invention there is provided a data structure comprising the combination of a result of a first non-coherent integration in a first frequency sub-space over a first epoch and a result of a second non-coherent integration in a second frequency sub-space over a second epoch.

According to another embodiment of the invention there is provided a computer program product comprising computer program instructions for combining a result of a first non-coherent integration in a first frequency sub-space over a first epoch with a result of a second non-coherent integration in a second frequency sub-space over a second epoch.

According to another embodiment of the invention there is provided a method of non-coherent integration in an environment subject to drift of a time reference, the method comprising: creating a first putative non-coherent integration value by assuming no-drift of the time reference; creating a second putative non-coherent integration value by assuming drift of a first rate of the time reference; and determining a non-coherent integration value using the first putative non-coherent integration value and the second putative non-coherent integration value.

According to another embodiment of the invention there is provided circuitry comprising : first circuitry for creating a first putative non-coherent integration value by assuming no-drift of the time reference and creating a second putative non-coherent integration value by assuming drift of a first rate of the time reference; and second circuitry for determining a non-coherent integration value using the first putative non-coherent integration value and the second putative non-coherent integration value.

According to another embodiment of the invention there is provided a computer program product comprising computer program instructions for creating a first putative non-coherent integration value by assuming no-drift of the time reference; creating a second putative non-coherent integration value by assuming drift of a first rate of the time reference; and determining a non-coherent integration value using the first putative non-coherent integration value and the second putative non-coherent integration value.

According to another embodiment of the invention there is provided a method comprising: storing first data associated with non-coherent integration, over only a first epoch, of a signal occupying only a first frequency space; and storing second data associated with non-coherent integration, over only a second epoch, of a signal occupying only a second frequency space, wherein the first epoch precedes the second epoch and the first frequency space is smaller than the second frequency space.

According to another embodiment of the invention there is provided circuitry comprising: first circuitry for storing first data associated with non-coherent integration, over only a first epoch, of a signal occupying only a first frequency space; and second circuitry for storing second data associated with non-coherent integration, over only a second epoch, of a signal occupying only a second frequency space, wherein the first epoch precedes the second epoch and the first frequency space is smaller than the second frequency space.

According to another embodiment of the invention there is provided a data structure comprising: a first data structure associated with non-coherent integration, over only a first epoch, of a signal occupying only a first frequency space and a second data structure associated with non-coherent integration, over only a second epoch, of a signal occupying only a second frequency space, wherein the first epoch precedes the second epoch and the first frequency space is smaller than the second frequency space.

According to another embodiment of the invention there is provided a computer program product comprising: instructions for storing first data associated with non-coherent integration, over only a first epoch, of a signal occupying only a first frequency space; and instructions for storing second data associated with non-coherent integration, over only a second epoch, of a signal occupying only a second frequency space, wherein the first epoch precedes the second epoch and the first frequency space is smaller than the second frequency space.

### BRIEF DESCRIPTION OF THE DRAWINGS

For a better understanding of the present invention reference will now be made by way of example only to the accompanying drawings in which:

FIG. 1 schematically illustrates a receiver for obtaining a position from GNSS satellites;

FIG. 2 schematically illustrates the receiver during channel acquisition;

FIG. 3 illustrates a process of frequency analysis and signal detection;

FIG. 4 illustrates the storage of non-coherent integration results separately for each epoch and the selective combination of the results; and

FIG. 5 is a schematic illustration of a device suitable for operating as a receiver 10.

### DETAILED DESCRIPTION OF EMBODIMENTS OF THE INVENTION

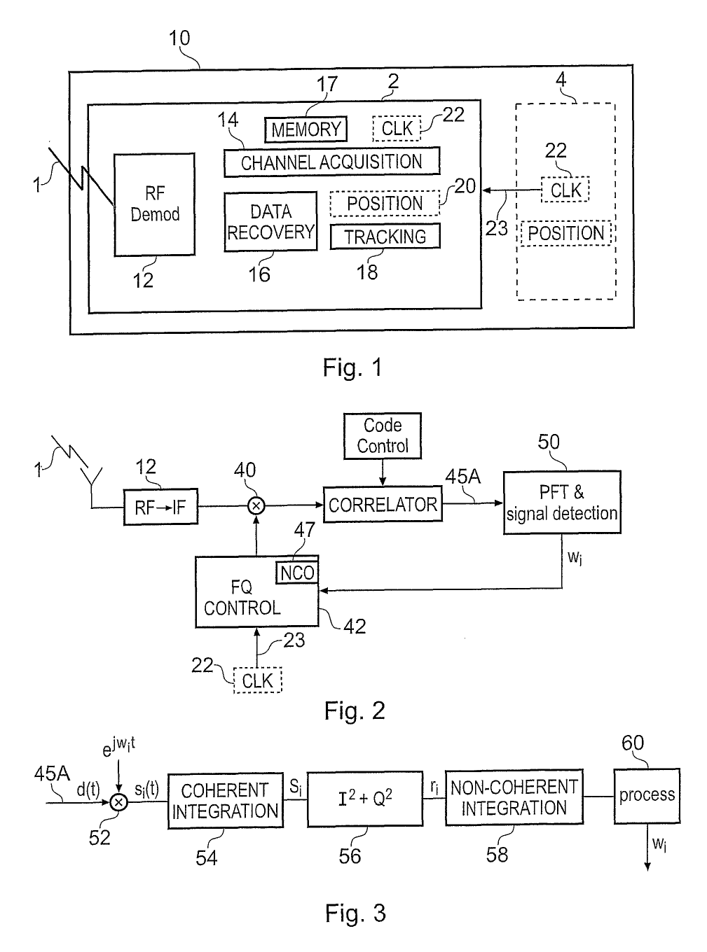

FIG. 1 schematically illustrates a receiver 10 for obtaining a position from GNSS satellites.

The receiver 10 comprises circuitry 2 that is dedicated to positioning the receiver 10. This circuitry 2 includes an RF engine 12 for demodulating RF signals, a measurement engine 14, 16, 18 for acquiring the satellite communication channels, for tracking the satellite communication channels and for recovering transmitted data from each of the satellite communication channels, a memory 17 for storing data and possibly a position engine 20 for solving time and geometric unknowns using the recovered data to determine the receiver system's position. The circuitry 2 may be provided as an integrated module.

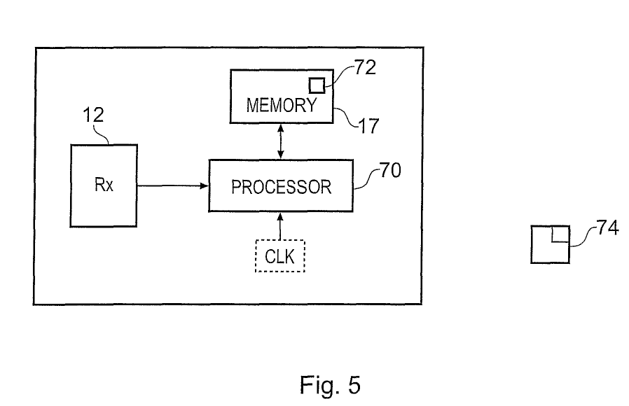

The engines may be provided via dedicated circuitry such as interconnected electronic components, integrated circuits or undedicated circuitry such as a programmable microprocessor (see FIG. 5).

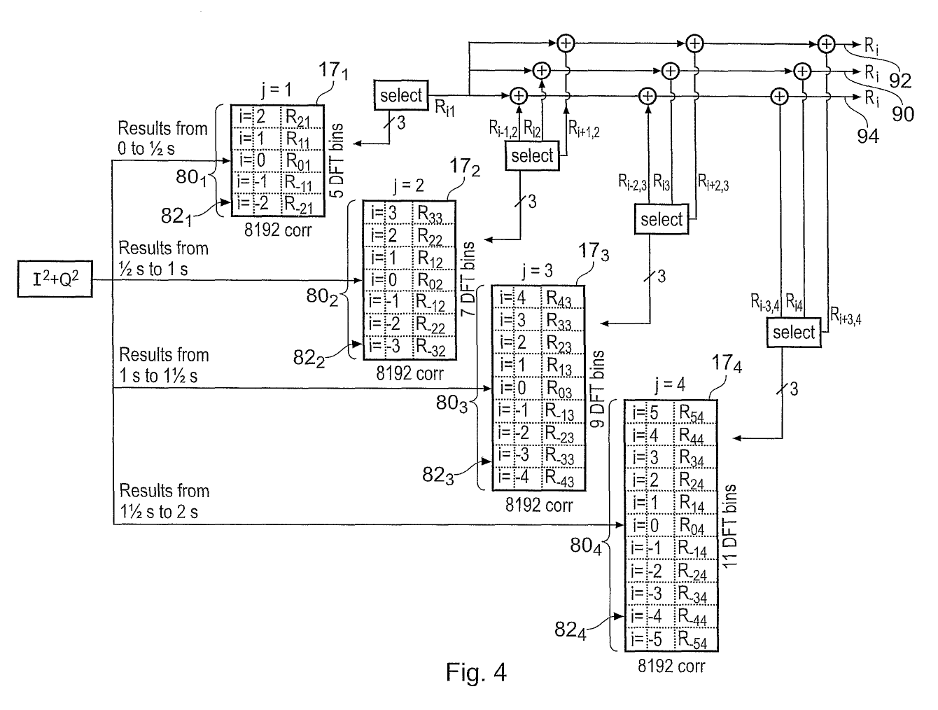

In FIG. 5, a processor 70 is connected to receive data from a receiver 12 and is connected to read from and write to the memory 17. The memory 17 stores computer program instructions 72 that control the operation of the electronic device when loaded into the processor 70. The computer program instructions 72 provide the logic and routines that enables the electronic device to perform the methods illustrated in FIGS. 3 and 4.

The computer program instructions 72 may arrive at the electronic device via an electromagnetic carrier signal or be copied from a physical entity 74 such as a computer program product, a memory device or a record medium such as a CD-ROM or DVD.

In one embodiment, the receiver 10 is a GNSS receiver device that comprises a clock 22. In another embodiment, the receiver 10 comprises a host system 4 comprising a host clock 22. The host system 4 typically uses the host clock 22 in the provision of some functions other than satellite positioning such as, for example, cellular radio telephone operation or computer bus operation.

The clock 22 provides a time signal 23 to the circuitry 2 which is used as a time reference. The clock 22 may be produced by a crystal oscillator. However such clocks are subject to errors for example a crystal oscillator's frequency may drift with temperature. The rate of possible drift will typically be engineered to be limited so that is does not exceed Z Hz/s e.g. 60 Hz/s.

Encoded data 1 is received via a communications channel that has been encoded using at least two parameters, typically frequency and a chipping code.

A GNSS satellite communications channel is separated from the other satellite communication channels of the same GNSS by a unique combination of chipping code and frequency. In GPS, each satellite shares the same frequency band but has a different chipping code, whereas in GLONASS each satellite uses the same chipping code but has a different frequency band. As each channel is associated with a different satellite that has a different velocity relative to a receiver, each communications channel has, because of, for example, the Doppler effect, its own unknown frequency within a nominal carrier frequency band. A communication channel can therefore be defined by the parameters: chipping code, chipping code phase, and frequency as affected by Doppler shift.

The chipping code phase gives an initial indication of the time of flight from the satellite to the receiver system 10 and is referred to as a pseudo-range. It is corrected for at least receiver clock error compared to the satellite clock before it represents a true range. It may also be corrected for satellite clock and orbit errors and RF signal transmission errors.

The measurement engine 14, 16, 18 comprises a channel acquisition block 14 for acquiring the satellite communication channels, a tracking block 18 for tracking the satellite communication channels and a data recovery block 16 for recovering transmitted data from each of the satellite communication channels. The blocks 14, 16 and 18 can also be combined in several different ways. In one embodiment one block can perform all functions of said blocks.

Acquisition, performed by channel acquisition bock 14, is the process that positioning circuitry 2 uses to find satellite communication channels given a set of starting conditions (or uncertainties). This involves achieving frequency lock and code phase alignment and normally decoding data sufficiently to enable determination of a pseudo-range for each of four satellites.

Tracking of a communications channel, performed by the tracking block 18, involves the maintenance of the at least two parameters that define the channel and occasionally updating Satellite Data information as this changes from time to time (e.g. every 2 to 4 hours for GPS).

A position engine 20 solves at least four equations with four unknowns using the four pseudo-ranges to make a three dimensional position fix. The four unknowns are the three degrees of freedom in the receiver position (x, y, z) and the receiver time according to the ‘true’ satellite time reference (phase code offset). The positioning circuitry 2 must therefore acquire four separate communication channels and obtain four pseudo-ranges.

FIG. 2 schematically illustrates positioning circuitry 2 during channel acquisition.

Encoded data 1 is received via an antenna and converted by the RF engine 12, it is then frequency shifted from an intermediate frequency IF to a baseband frequency by mixer 40 under the control of frequency controller 42. The frequency controller 42 may be a numerically controlled oscillator (NCO) 47 which uses as its clock the time reference 23.

The baseband frequency signal is correlated by correlator block 44 to produce a partially encoded signal 45A.

In this example, the positioning circuitry 2 is a GPS receiver and the encoded data is encoded using a satellite specific chipping code but a common frequency band offset by a satellite specific Doppler shift.

The correlator block 44 may be implemented as described in relation to FIG. 3 or 6 of WO 2005/104392 A1 as a group correlator.

In one embodiment of a group correlator, a chipping code is shifted into a code shift register of size N at a rate of one bit per chip. Simultaneously, the baseband signal is shifted into a sample shift register of size N at a rate of one bit per chip. Every N chips the content of the code shift register is transferred to a code register. Every chip the N bits of the code register are cross correlated with the respective N bits of the sample shift register. The code registers may be cascaded in series so that at any one time each holds a different sequential N bit portion of the same chipping code. In this case, each of the cascaded code registers is cross-correlated with the sample shift register in each chip period.

In another embodiment of the group correlator, the chipping code is shifted into a code shift register of size N at a rate of several bits per chip. Simultaneously, the baseband signal is shifted into a sample shift register of size N at the same rate of several bit per chip.

The same process may occur for different chipping codes in parallel group correlators.

The code controller 46 controls the codes and code parts provided to the respective code shift registers. The code controller may be programmable so that different code formats may be used.

The correlator block 44 because it correlates a part of the chipping code of size N, against N sequential samples, has an effective sampling rate of N times the chipping rate and is therefore able to search an increased frequency bandwidth. In fact it is able to search the whole of the frequency bandwidth for each of the chipping codes in parallel. This enables the correlator block to identify for received encoded data the relevant chipping codes and estimates of their respective chipping code phases without having to first determine their respective frequencies.

The output from the correlator block 44, the partially encoded data 45A is decoded using frequency analysis and signal detection 50 using, for example, a Fast Fourier Transform or Discrete Fourier Transform. The frequency analysis and signal detection 50 identifies the frequencies wᵢ of the communication channels which are returned to the frequency controller 42 where they may be used as a numeric input to the NCO.

The operation of the frequency analysis and signal detection block 50 is illustrated in more detail in FIG. 3.

The partially encoded data d(t) 45A is converted to the frequency domain by multiplication, using multiplier 52, separately with each of exp(jwᵢ t) for i=0, +1, −1, +2, −2, . . . +N, −N. The frequency wᵢ is the central frequency of a frequency bin. The frequency bins may have the same fixed size W, in which case wᵢ=wₒ+i*W.

sᵢ(t)=d(t)*exp(jwᵢ t) for i=0, +1, −1, +2, −2, . . . +N, −N

The resultant signals sᵢ are each coherently integrated, in block 54, over a time T_{c} to create Sᵢ:

$${S}_{i} = {\int }_{t = 0}^{{T}_{c}} {S}_{i} ( t ) d t$$

Each of the signals Sᵢ is then converted from a vector quantity I+jQ to a scalar quantity rᵢ in block 56 where rᵢ=I²+Q². Several other methods of converting the vector quantity to scalar can be used, e.g. rᵢ=sqrt(I²+Q²)

Previously, the resultant signals rᵢ have been non-coherently integrated over a time T_{nc} to create Rᵢ:

$${R}_{i} = {\int }_{t = 0}^{{T}_{nc}} {r}_{i} ( t ) d t$$

The coherent integration and the non-coherent integration increase the signal to noise ratio (SNR).

The longer the coherent integration time T_{c} the greater the sensitivity of the receiver 10. However, as the coherent integration time T_{c} is increased the width of the frequency bins W are decreased which increases the sensitivity of the receiver to clock changes such as drift. The coherent integration time T_{c} may be limited by an attribute of the signal 1 such as the bit length of BPSK encoded data in GPS which limits the coherent integration time to 20 ms at present.

The longer the non-coherent integration time T_{nc} the greater the sensitivity of the receiver. However, as the coherent integration time T_{c} is increased the size of the memory 17 required for storing Rᵢ increases.

The inventors have developed an improved frequency analysis and detection block 50 and, in particular, improvements to the non-coherent integration process 58 and the use of the results in process 60.

Let us divide the non-coherent integration time T_{nc} into time epochs (periods) Xⱼ. where j=0, 1, 2, 3 . . . M where M is any natural number and Xₒ=0.

Let

$${R}_{ij} = {\int }_{{X}_{j - 1}}^{{X}_{j}} {r}_{i} ( t ) d t$$

when j=1, −m₁<i<+m₁, where m₁<N

when j=2, −m₂<i<+m₂, where m₂>m₁ and m₂<N,

when j=3, −m₃<i<+m₃, where m₃>m₂ and m₃<N,

The values of m, W and X may be chosen based up the maximum drift rate Z of the clock e.g. Z<(mⱼ−mⱼ₋₁)*W/Xⱼ

Typically m₂=m₁+c and m₃=m₂+c, where c is a constant natural number such as 1, 2 . . .

In one embodiment, the time epochs Xⱼ have the same size X for all j and c is 1. In this embodiment, Z<W/X.

It will therefore be appreciated that in the first time epoch X₁ the non-coherent integration value Rᵢ₁ is stored in memory 17 only for each frequency bin in a first sub-set (−m₁<i<+m₁) of the total 2N+1 frequency bins. The set {Rᵢ₁: −m₁<i<+m₁} is stored as a first data structure 17₁ with each value Rᵢ₁ stored in its own data portion. The range of i defines a first frequency space 80₁.

In the second time epoch X₂, the non-coherent integration value Rᵢ₂ is stored in memory 17 only for each frequency bin in a second sub-set (−m₂<i<+m₂) of the total 2N+1 frequency bins. The set {Rᵢ₂: −m₂<i<+m₂} is stored as a second data structure 17₂ with each value Rᵢ₂ stored in its own data portion. The range of i defines a second frequency space 80₂.

In the third time epoch X₃ the non-coherent integration value Rᵢ₃ is stored in memory 17 only for each frequency bin in a second sub-set (−m₃<i<+m₃) of the total 2N+1 frequency bins. The set {Rᵢ₃: −m₃<i<+m₃} is stored as a third data structure 17₃ with each value Rᵢ₃ stored in its own data portion. The range of i defines a third frequency space 80₃.

Until, in a final time epoch X_{M} the non-coherent integration value R_{iM} is stored in memory 17 for each frequency bin of the total 2N+1 frequency bins. The set {R_{iM}: −m_{M}<i<+m_{M}} is stored as a first data structure 17_{M} with each value Rᵢ₁ stored in its own data portion. The range of i defines a first frequency space 80_{M}. In the example illustrated in FIG. 4, M=4.

In FIG. 4, in the first 1/2 second, the non-coherent integration values Rᵢⱼ for each of the five contiguous frequency bins i=−2, −1, 0, 1, 2 are stored in the first data structure 17₁. In the second ½ second, the non-coherent integration values for each of seven frequency bins i=−3, −2, −1, 0, 1, 2, 3 are stored in the second data structure 17₂. The seven frequency bins include the five contiguous frequency bins used for the preceding epoch and the frequency bin i=3 adjacent to but above that set of five frequency bins and the frequency bin i=−3 adjacent to but below that set of five frequency bins. In the third ½ second, the non-coherent integration values for each of nine frequency bins i=−4, −3, −2, −1, 0, 1, 2, 3, 4 are stored in the third data structure 17₃. The nine frequency bins include the seven contiguous frequency bins used for the preceding epoch and the frequency bin i=4 adjacent to but above that set of seven frequency bins and the frequency bin i=−4 adjacent to but below that set of seven frequency bins. In the forth ½ second, the non-coherent integration values for each of eleven frequency bins i=−5, −4, −3, −2, −1, 0, 1, 2, 3, 4, 5 are stored in the fourth data structure 17₄. The eleven frequency bins include the nine contiguous frequency bins used for the preceding epoch and the frequency bin i=5 adjacent to but above that set of nine frequency bins and the frequency bin i=−5 adjacent to but below that set of nine frequency bins.

It will therefore be appreciated that that non-coherent integration 58 is not performed over a large fixed number of frequency bins (fixed frequency space) for the whole period T_{nc} but the period T_{nc} advantageously is divided into a number of epochs and non-coherent integration is performed over an increasing number of frequency bins with subsequent epochs. The size of the frequency search space 80 therefore increases with subsequent epochs and, in the example of FIG. 4, increases linearly with time at a rate of two frequency bins (one positive, one negative) per epoch.

The results of the non-coherent integration are then processed at block 60 to identify the strongest signal(s).

This processing, as illustrated in FIG. 4, takes a non-coherent integration value Rij for each epoch j and adds these values to create a final non-coherent integration value Ri. The size of this value Ri, if large, is indicative of a received signal and also the frequency wᵢ for that signal. This frequency value can be used to program the NCO 47 in the frequency controller 42.

The processing assumes a putative no-drift solution 90 and putative drift solutions 92, 94. In a putative no-drift solution 90, the final non-coherent integration value Ri is created by summing non-coherent integration values for each epoch that share the same frequency space (i.e. the same frequency bin wᵢ). In a drift solution 92, 94, the final non-coherent integration value Ri is created by summing non-coherent integration values Rij for each, epoch that are from different frequency spaces j, where the frequency space may drift linearly with each passing epoch.

The size of the value Ri, for all drift and no-drift solutions, for all i, are compared and a large value, is indicative of a received signal and also the frequency wᵢ for that signal. This frequency value can be used to program the NCO 47 in the frequency controller 42.

No Drift Solution 90

$${R}_{i} = {\sum }_{j = 1}^{M} {R}_{ij}$$

in the example of FIG. 4, l=1 and k=1

Rᵢ=Rᵢ₁+Rᵢ₂+Rᵢ₃+Rᵢ₄ for i=−2, −1, 0, 1, 2

Positive Drift Solution 92

$${R}_{i} = {\sum }_{j = 1}^{M} {R}_{i + {c}^{*} ( j - 1 ) , j}$$

in the example of FIG. 4, c=1

Rᵢ=Rᵢ₁+R_{i+1,2}+R_{i+2,3}+R_{i+3,4}, for i=−2, −1, 0, 1, 2

Negative Drift Solution 94

$${R}_{i} = {\sum }_{j = 1}^{M} {R}_{i - {c}^{*} ( j - 1 ) , j}$$

in the example of FIG. 4 c=1

Rᵢ=Rᵢ₁+R_{i-1,2}+R_{i-2,3}+R_{i-3,4}, for i=−2, −1, 0, 1, 2

Although embodiments of the present invention have been described in the preceding paragraphs with reference to various examples, it should be appreciated that modifications to the examples given can be made without departing from the scope of the invention as claimed. For example, in the examples presented above it has been assumed that c is greater than or equal to one. c may be less than one i.e. the drift may be less than two frequency bins (one positive, one negative) per epoch. For example, if the frequency drift rate is half that of the positive drift solution given above, Rᵢ=Rᵢ₁+Rᵢ₂+R_{i+1,3}+R_{i+1,4}. For example, if the frequency drift rate is half that of the negative drift solution given above, Rᵢ=Rᵢ₁+Rᵢ₂+R_{i-1,3}+R_{i-1,4}.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A method in which a non-coherent integration period is divided into a plurality of epochs and a frequency space is divided into a plurality of sub-spaces, the method comprising:
combining a result of a first non-coherent integration in a first frequency sub-space over a first epoch with a result of a second non-coherent integration in a second frequency sub-space over a second epoch.

2. A method as claimed in claim 1, wherein the first frequency sub-space and second frequency sub-space are neighboring contiguous sub-spaces.

3. A method as claimed in claim 1, wherein first epoch and second epoch are neighboring contiguous time periods.

4. A method as claimed in claim 1, wherein the difference in frequency between the second and first frequency sub-spaces divided by the time difference between the second and first epochs has a predetermined value.

5. A method as claimed in claim 4, wherein the predetermined value corresponds to an estimate of a time reference drift.

6. A method as claimed in claim 1, further comprising combining a result of the first non-coherent integration in a first frequency sub-space over the first epoch with a result selected from the group comprising:
a result of a third non-coherent integration in the first frequency sub-space over the second epoch;
a result of a fourth non-coherent integration in a third frequency sub-space over the second epoch.

7. (canceled)

8. A method as claimed in claim 6, wherein first frequency sub-space and the third frequency sub-spaces are neighboring contiguous sub-spaces.

9. A method as claimed in claim 7, wherein first epoch and second epoch are neighboring contiguous time periods.

10. A method as claimed in claim 1, comprising summing non-coherent integration values, for each successive epoch, that are from different frequency sub-spaces.

11. A method as claimed in claim 9, wherein the frequency sub-space used drifts linearly with each passing epoch.

12. A method as claimed in claim 1, further comprising:
storing as first data, data associated with non-coherent integration, over only the first epoch, of a signal occupying only a first frequency space; and storing as second data, data associated with non-coherent integration, over only the second epoch, of a signal occupying only a second frequency space, wherein the first epoch precedes the second epoch and the first frequency space is smaller than the second frequency space, wherein the first frequency space is divided into a first plurality of distinct frequency sub-spaces and the first data comprises a first Plurality of data portions each of which is associated with non-coherent integration, over only the first epoch, of a signal occupying only one of the first plurality of frequency sub-spaces and wherein the second frequency space is divided into a second Plurality of distinct frequency sub-spaces and the second data comprises a second plurality of data portions each of which is associated with non-coherent integration, over only the second epoch, of a signal occupying only one of the second plurality of frequency sub-spaces.

13. (canceled)

14. (canceled)

15. Circuitry comprising:
first circuitry arranged to perform a first non-coherent integration in a first frequency sub-space over a first epoch and a second non-coherent integration in a second frequency sub-space over a second epoch, and
second circuitry arranged to combine a result of the first non-coherent integration with a result of the second non-coherent integration.

16. A device or module comprising the circuitry as claimed in claim 15.

17. (canceled)

18. (canceled)

19. A computer program product tangibly embodied on a memory device comprising computer program instructions which when loaded into a processor control combining a result of a first non-coherent integration in a first frequency sub-space over a first epoch with a result of a second non-coherent integration in a second frequency sub-space over a second epoch.

20. A method of non-coherent integration in an environment subject to drift of a time reference, the method comprising:
creating a first putative non-coherent integration value by assuming no-drift of the time reference;
creating a second putative non-coherent integration value by assuming drift of a first rate of the time reference; and
determining a non-coherent integration value using the first putative non-coherent integration value and the second putative non-coherent integration value.

21. A method as claimed in claim 20, wherein the step of determining the non-coherent integration value involves selecting one of the first putative non-coherent integration value and the second putative non-coherent integration value

22. A method as claimed in claim 20, wherein the step of determining the non-coherent integration value involves combining the first putative non-coherent integration value and the second putative non-coherent integration value.

23. A method as claimed in claim 22, wherein the non-coherent integration period is divided into a plurality of epochs and a frequency space is divided into a plurality of sub-spaces, wherein creating a first putative non-coherent integration value by assuming no-drift of the time reference involves combining a result of a first non-coherent integration in a first frequency sub-space over a first epoch with a result of a second non-coherent integration in the first frequency sub-space over a second epoch and wherein creating a second putative non-coherent integration value by assuming drift of a first maximum rate of the time reference involves combining a result of a first non-coherent integration in a first frequency sub-space over a first epoch with a result of a third non-coherent integration in a second frequency sub-space over the second epoch.

24. Circuitry comprising:
first circuitry for creating a first putative non-coherent integration value by assuming no-drift of the time reference and creating a second putative non-coherent integration value by assuming drift of a first rate of the time reference; and
second circuitry for determining a non-coherent integration value using the first putative non-coherent integration value and the second putative non-coherent integration value.

25. A computer program product comprising computer program instructions for creating a first putative non-coherent integration value by assuming no-drift of the time reference;
creating a second putative non-coherent integration value by assuming drift of a first rate of the time reference; and
determining a non-coherent integration value using the first putative non-coherent integration value and the second putative non-coherent integration value.

26.-43. (canceled)
